(19) United States
(12) Patent Application Publication
(10) Pub. No.: US 2005/0199333 A1
(43) Pub. Date: Sep. 15, 2005

(54) Tail for attaching the trailing edge of one roll of tape to the leading edge of another roll of tape and method of using same

(75) Inventors: Gilles Cyr, Eugene, OR (US); Elvin Dalebout, Junction City, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: Industrial Adhesives, Inc.

(21) Appl. No.: 11/051,066

(22) Filed: Feb. 4, 2005

Related U.S. Application Data
(63) Continuation-in-part of application No. 10/623,136, filed on Jul. 17, 2003.
Application No. 10/623,136 is a continuation-in-part of application No. 09/963,190, filed on Sep. 25, 2001, now Pat. No. 6,596,111.

(51) Int. Cl. B65C 3/26; B32B 31/00; B65H 19/00

(52) U.S. Cl. 156/156; 156/266; 156/502

(57) ABSTRACT

A tape splicing mechanism joins the tail of one tape to the leading edge of another tape. A frame defines a passageway along which the tape passes. A pair of arms rotatably attached to the frame have projecting posts and rotate between a first position where the posts are closer to the pathway and a second position where they are further from the pathway. The arms are urged toward the first position and a catch mechanism holds them in the second position until released by a release mechanism when a release indicia in the first tape passes. The leading edge of the second tape is looped around the first tape to form a loose knot and is tied to the post on each side of the first tape. When the arms are released they move to the second position and tighten the knot.

### CROSS-REFERENCE TO RELATED APPLICATIONS

This application is a continuation-in-part of application Ser. No. 10/623,136, filed Jul. 17, 2003 which is a continuation-in-part of application Ser. No. 09/963,190, filed Sep. 25, 2001, now U.S. Pat. No. 6,596,111.

### BACKGROUND AND SUMMARY OF THE INVENTION

The subject invention relates to a tail which is used to attach the trailing edge of tape from one roll to the leading edge of tape from another roll and to a method of using this tail to join rolls of tape together.

There are numerous applications where a continuous supply of tape material must be provided. When this occurs there needs to be a way of attaching the trailing edge of one roll of tape to the leading edge of another roll of tape without interrupting the feeding of the tape. This can be accomplished by placing a mechanical fastening device on the tape or by adhesively joining the two tapes together. An example of the latter is the system disclosed in U.S. Pat. No. 6,325,324, now U.S. Pat. No. 6,325,324. Here the trailing edge of the tape on each roll is wrapped around a plate to provide an end piece which is thicker than the remainder of the tape. The leading edge of the tape on each roll has an adhesive coating applied to it. The leading edges of both rolls are then fed into a splicer block having a pair of spaced-apart pincher rollers which are separated by a distance which is greater than the thickness of two pieces of tape, but less than the thickness of one piece of tape and the end piece. Thus, when the tape from one of the rolls is pulled through the splicer block, as the trailing end of that roll passes through the pincher rollers the end piece is squeezed against the adhesive at the leading edge of the tape from the other roll, and the two pieces of tape are joined. While simple and inexpensive, this system does not always cause the two pieces of tape to be joined. Because the adhesive is exposed during the entire time the preceding roll of tape is being unwound, it can collect dust and other contaminants and become less adherent. In addition, in order for the adhesive to even be squeezed against the end piece it must be located precisely between the pincher rollers. If the operator does not do this correctly or if the moving tape drags the non-moving tape out of the pincher rollers the rolls will not be joined. In addition, the second roll can only be installed on the device which rotatively carries it in one direction in order that the adhesive side of the tape is facing the moving tape. If adhesive is put on both sides of the tape to make it reversible, the adhesive on the other side may very well stick to the pincher rollers enough that the short period of time the adhesive is exposed to the moving tape may not be enough to release it.

The subject invention overcomes the shortcomings and limitations of the prior art by providing a bulge in a tail that is attached to the trailing edge of the tape on each roll. This bulge has an adhesive coating on both sides. Protective elements are located on the tail on each side of the bulge in a manner that one of the protective elements covers the adhesive coating on each side of the bulge. As a result, when the tail is rolled onto a roll core the adhesive coating is protected by the protective element and will not stick to the roll core or to adjacent layers of the tail or tape. The protective element is configured such that it readily parts from the adhesive coating when the tail is unwound from the roll core.

In addition the leading edge of the tape from the second roll is wrapped around the tape from the first roll to form a loose knot. When the leading edge of the tape from the second roll is adhered to the adhesive on the bulge on the tail on the trailing edge of the second roll the knot is tightened so that the second roll becomes tied to the first roll as well.

In another embodiment of the invention the tail of tape being fed from one roll is joined to the leading edge of tape which will be fed from another roll by placing a marker in the trailing edge of the tape from the first roll and passing the tape from the first roll through a splicer mechanism. A second roll of tape has a leading edge which is looped around the tape from the first roll to form a loose knot. A knot tying mechanism causes the loose knot in the tape from the second roll to be tightened around the tape from the first roll when the marker in the trailing edge of the tape from the first roll passes through the splicer mechanism.

### BRIEF DESCRIPTION OF THE DRAWINGS

FIG. 1 is an exploded view showing a tail embodying the subject invention.

FIG. 2 is an exploded view showing how the tail of FIG. 1 is wound onto a roll core.

FIGS. 3 and 4 are side elevation views of a splicer mechanism showing how the trailing edge of a first piece of tape is spliced to the leading edge of a second piece of tape.

FIG. 5 is a perspective view of another splicer mechanism embodying the subject invention.

FIG. 6 is a front view of the splicer mechanism of FIG. 5.

FIG. 7 is a rear view of the splicer mechanism of FIG. 5.

FIGS. 8 and 9 are front views of the splicer mechanism of FIG. 5 showing its sequence of operation.

FIG. 10 is a front view of another embodiment of the invention.

FIG. 11 is a front view of yet another embodiment of the invention.

FIG. 12 is a detail view showing how a bulge is placed in the tape.

FIG. 13 is a perspective view of yet another splicer mechanism embodying the subject invention.

FIG. 14 is a rear view of the splicer mechanism of FIG. 13 partially broken away to show hidden detail.

FIG. 15 is a front view of the splicer mechanism of FIG. 13.

FIGS. 16, 17 and 18 are front views of the splicer mechanism of FIG. 13 showing its sequence of operation.

### DETAILED DESCRIPTION OF A PREFERRED EMBODIMENT

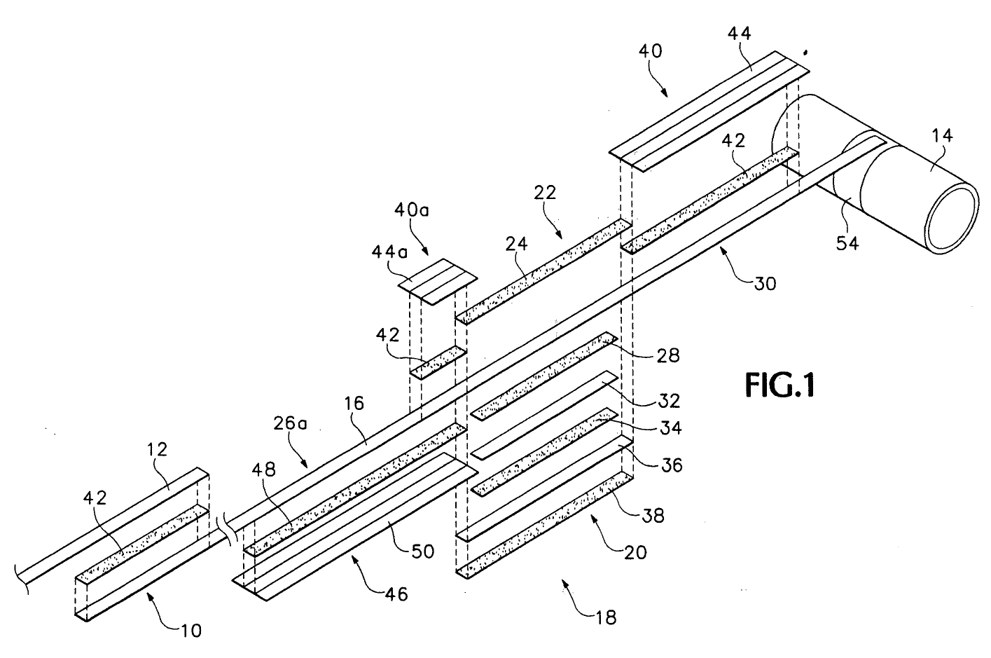

Referring to FIG. 1 of the drawings, a transfer tail 10 is attached to the trailing edge of a length of tape or tape-like material 12 which is wound onto a cylindrical roll core 14 to form a roll of tape (not shown). The purpose of the transfer tail is to automatically attach the trailing edge of the tape as it is removed from the roll to the leading edge of the tape from another roll without stopping the supply of tape to its intended application.

The tail 10 includes a tail base 16 which is made from the same or a similar material as the tape 12. The tail base preferably is 4-5 feet long, but its length is not limited. It does need to have a thickness which is similar to the thickness of the tape 12. Located on the tail base 16 near its trailing edge is a bulge 18 having a thickness which is greater than the thickness of the tail base. The bulge has an inside face 20 and an outside face 22, both of which have an adhesive coating.

In the preferred embodiment illustrated, the bulge is formed by placing a piece of double-sided tape 24, with a the protective film removed from both sides, on the first side 26 of the tail base 16. This provides the adhesive coating on the outside face 22 of the bulge. The length of the piece of double-sided tape 24 is important, as will be explained later. Another piece of double-sided tape 28, which is slightly shorter than the piece of double-sided tape 24, is placed on the second side 30 of the tail base 16 directly across from and centered over the piece of tape 24. The protective film is removed from both sides of the piece of double-sided tape 28 also. An obstruction piece 32 is placed on top of the piece of double-sided tape 28 and the obstruction piece in turn is covered with another piece of double-sided tape 34 which has the protective film removed from both sides. The obstruction piece is thicker than the tail base 16 or the double-sided tape 24, 28, 34 and it is flexible. The obstruction piece 32 and the piece of double-sided tape 34 have the same length as a piece of double-sided tape 28. A cover 36, made from the same material as the tail base and having the same length as the piece of double-sided tape 24, is then placed over the piece of double-sided tape 34. Since the cover 36 is longer than the pieces of double-sided tape 28 and 34 and the obstruction piece 32, it extends outwardly from each side of them. This permits the ends of the cover 36 to be attached to the tail base in order to make a smooth transition between the bulge and the remainder of the tail base. If the cover and the tail base are a heat-sealable material they can be heat sealed together. Otherwise they can be joined with an adhesive. Finally, another piece of double-sided tape 38, having the same length as the cover 36, is located on top of the cover. The film is removed from both sides of the piece of double-sided tape 38. This provides the adhesive surface on the inside face 20 of the bulge. Thus, there is an exposed adhesive surface on both sides of the bulge.

Located on the first side 26 of the tail base 16, towards its trailing edge from the bulge 18, is a first protective element 40. The protective element 40 will cover the exposed adhesive on the inside face 20 of the bulge when the tail 10 is wrapped onto the roll core. The length of the first protective element 40 is slightly greater than the length of the bulge 18, as will be more fully explained later. In the embodiment illustrated, the first protective element includes a piece of double-sided tape 42 with the protective film removed from both sides. Another piece of protective film 44, which is wider, is placed on top of the piece of double-sided tape 42.

In the embodiment illustrated a portion of the first protective element 40a is placed on the leading edge side of the bulge 18 also. The protective element 40a includes a piece of double-sided tape 42a and a piece of wide protective film 44a. Placing a portion of the first protective element on the other side of the bulge is not required, but it may be useful for reasons that will be described later.

Located on the second side 30 of the tail base 16, towards its leading edge from the bulge, is a second protective element 46. The second protective element 46 preferably has substantially the same length as the first protective element 40. All that is required, however, is that it be longer than the bulge. The second protective element 46 includes a piece of double-sided tape 48, with the protective film removed from both sides. This piece of double-sided tape 48 is covered with a wider piece of protective film 50.

Located on either side of the tail base 16, at its leading edge, is a piece of double-sided tape 52. The protective film is removed from this piece of double-sided tape when the tail 10 is joined to the trailing edge of the tape 12.

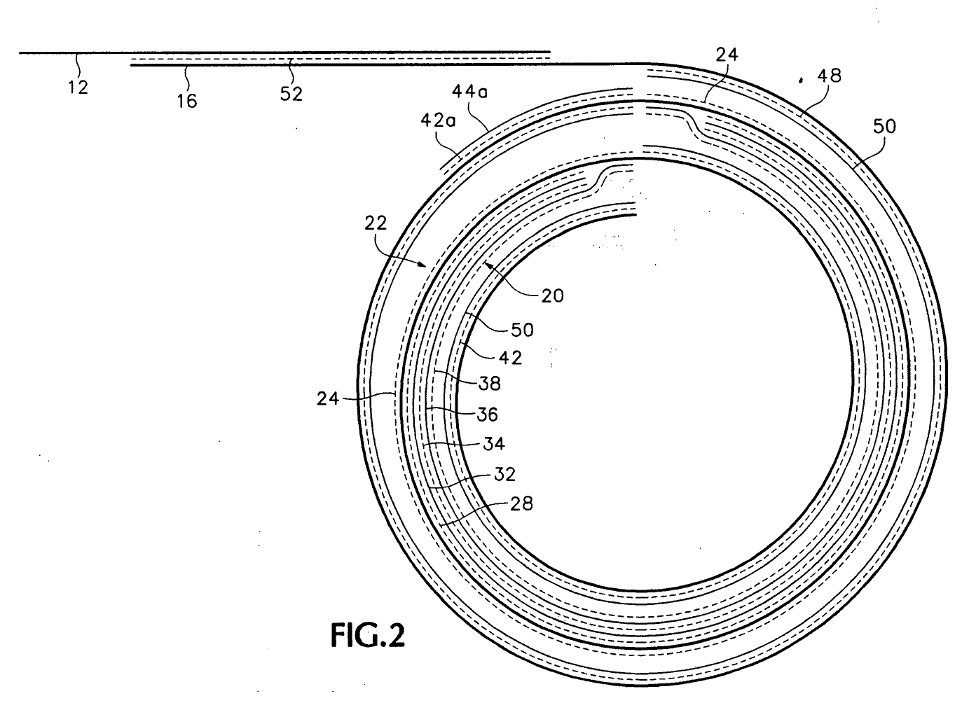

Once the tail 10 is attached to the trailing end of the tape 12 the tail and tape are wound on top of itself onto a roll core 14, FIG. 2. To ensure that the unprotected segment of the adhesive coating on the bulge does not stick to the roll core, a piece of double-sided tape 54 with the protective film removed from one side only is wound around the center of the roll core.

As the tail 10 is wound onto the roll core 14 the first protective element 40 faces outwardly from the roll. The length of the first protective element should be equal to or slightly greater than the circumference of the roll core. Thus, the first protective element extends entirely around the roll. As the tail continues to be wound onto the roll core, the inside face 20 of the bulge will overlie the protective element 40. Since the length of the bulge is less than the length of the first protective element the first protective element completely covers the inside face of the bulge. The protective film that is used to cover double-sided tape has a higher rate of adhesion on its inside surface than it does on its outside surface. Thus, when the tail is later unwound from the roll core the protective film will remain adhered to the protective element and will readily pull away from the adhesive layer on the bulge exposing the adhesive layer.

At this point the outside face 22 of the bulge faces outwardly from the roll. As the tail continues to be wound onto the roll the second protective element 46 overlies the outside face 22 of the bulge and the protective film covers the adhesive on this side of the bulge.

The second portion 40a of the first protective element is placed on the tail base 12 a spaced distance from the trailing edge of the bulge which ensures that the leading edge of the double-sided tape 24 does not extend past the end of the protective film 50.

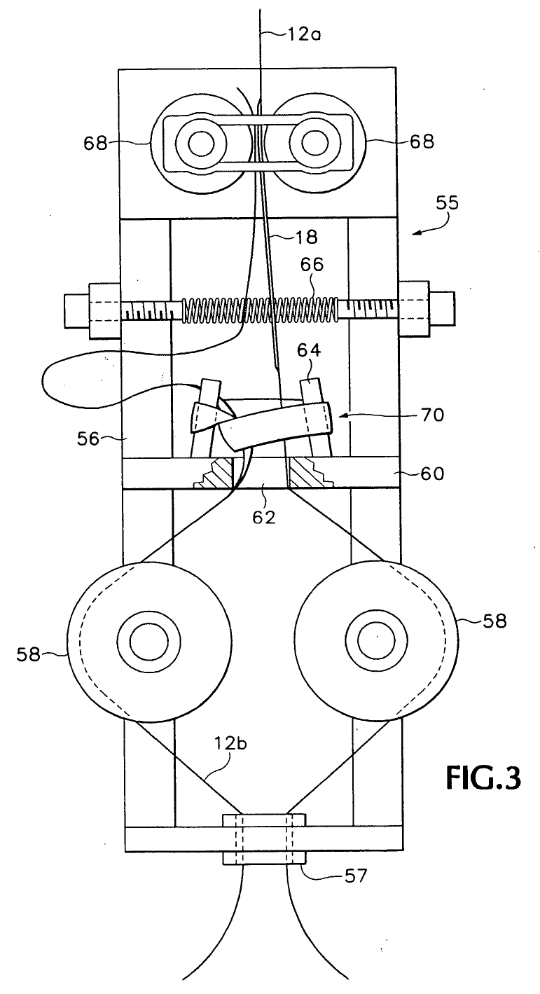

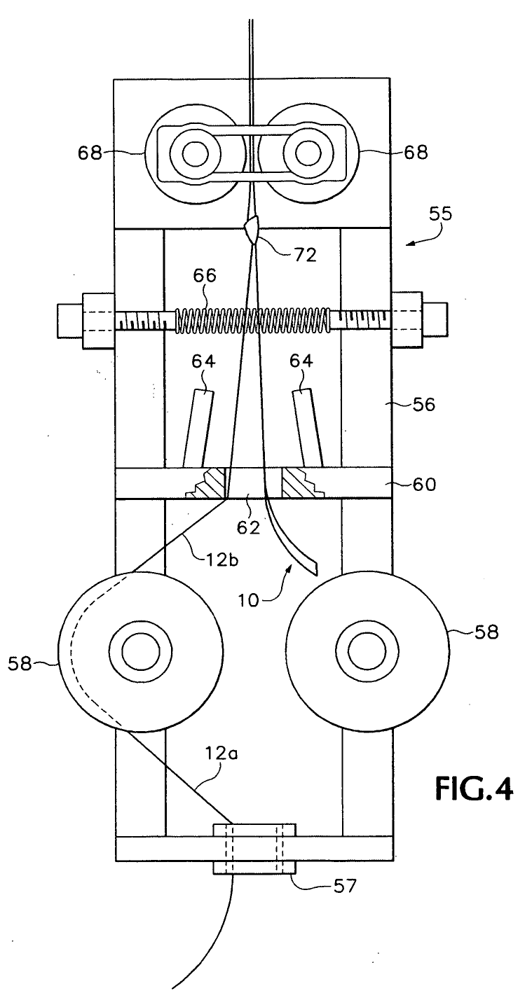

Referring now to FIGS. 3 and 4, a splicer mechanism 55 that is used to join the tail 10 of one roll of tape to the leading edge of another roll includes a frame 56 having an entry passageway 57 located at its lower end. Located above the entry passageway 57 is a pair of spaced-apart guide rollers 58. Located above the guide rollers is a bridge 60 with a guide orifice 62 passing centrally through it. Extending upwardly from the bridge 60 on each side of the guide orifice is a pair of pins 64 which angle toward one another. A tape-holding device, such as a spring 66, is located above the bridge 60, and a pair of side-by-side pincher rollers 68 are located above the spring. The distance between the pinching rollers is greater than the combined width of the tape 12 but less than twice the width of the tape and the bulge 18.

The leading edge of the tape 12a from a first roll is fed through the passageway 57 and around one of the guide rollers 58. It is then passed through the guide orifice 62, between the coils of the springs 66, and through the pincher rollers 68. The leading edge of the tape 12b from a second roll is then inserted through the passageway 57, around the other guide roller 58 and through the guide orifice 62. The second tape 12b is then looped around the first tape and pins 64 and back through itself to form a loose half-hitch knot 70. The second tape is then placed between the coils of the springs 66 and through the pincher rollers 68. The first tape 12a is then pulled off of the roll by a device which applies the tape. The distance between the pinch rollers 68 allows the first tape 12a to run freely without effecting the stationary second tape 12b. The spring 66 creates a resistance against the movement of the second tape which also prevents it from moving with the first tape.

As the bulge 18 in the first tape passes through the pincher rollers, FIG. 3, the rollers pinch it against the second tape and the second tape is engaged by the adhesive surface of the bulge. Thus the second tape begins to move with the first tape 12a. As the second tape starts to move the loose knot 70 becomes tightened around the first tape 12a and a tight knot 72 is formed which mechanically attaches the leading edge of the second tape to the tail of the first tape. The first roll is then replaced with a third roll and the process is repeated.

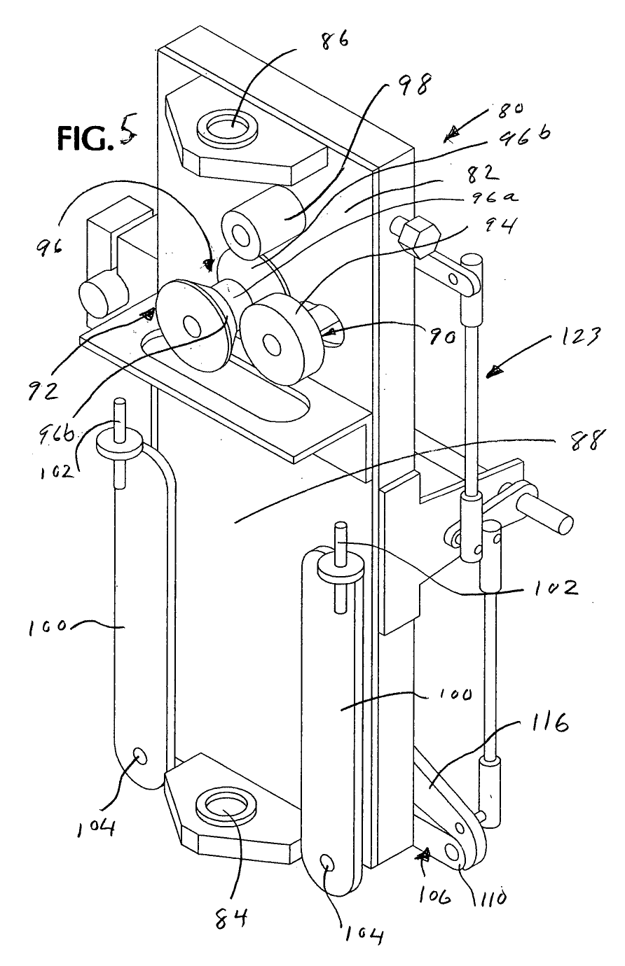

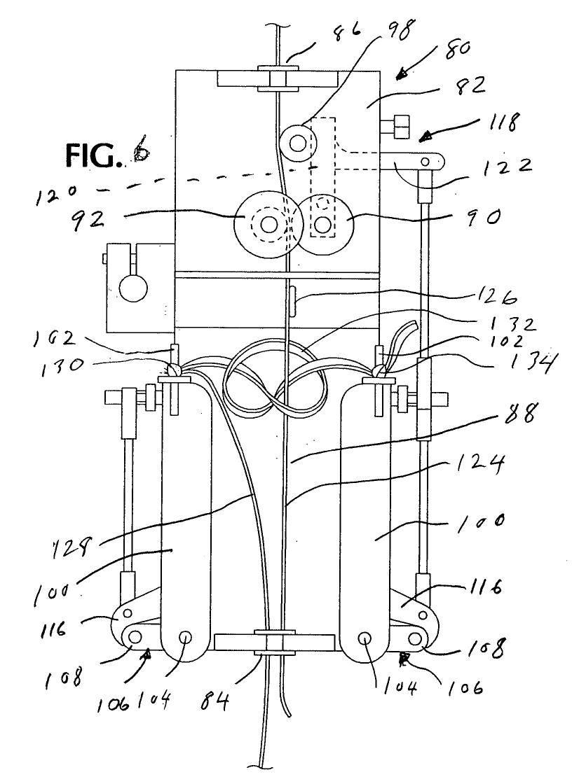

In another embodiment of the invention, shown in FIGS. 5-18, the adhesive is eliminated altogether and tightening the loose knot in the leading edge of the tape from the second roll around the tail of the tape from the first roll is the only means of attachment. Referring to FIG. 5, a first splicer mechanism 80 includes a frame 82. Located at the lower edge of the frame is an entry passageway 84 and located at the upper end of the frame is an exit passageway 86. Tape fed through the upper and lower passageways travels across the frame over a defined pathway 88. Located near the upper end of the frame is a movable roller 90 and a fixed roller 92. The tape passes between these two rollers but the rollers are separated from one another by a sufficient distance that they create negligible drag on the tape and the tape causes little, if any, rotation of the rollers under normal operating conditions. The face 94 of the movable roller 90 is flat, and the face 96 of the fixed roller 92 has a flat center 96a having a width which is slightly greater than the width of the face 94 of the movable roller 90. Located on each side of the center 96a are outwardly flared sections 96b. This shape causes the tape to remain centered between the two rollers. An idler roller 98, which is located above the rollers 90 and 92, pushes the tape toward the fixed roller 92 which also helps keep the tape centered.

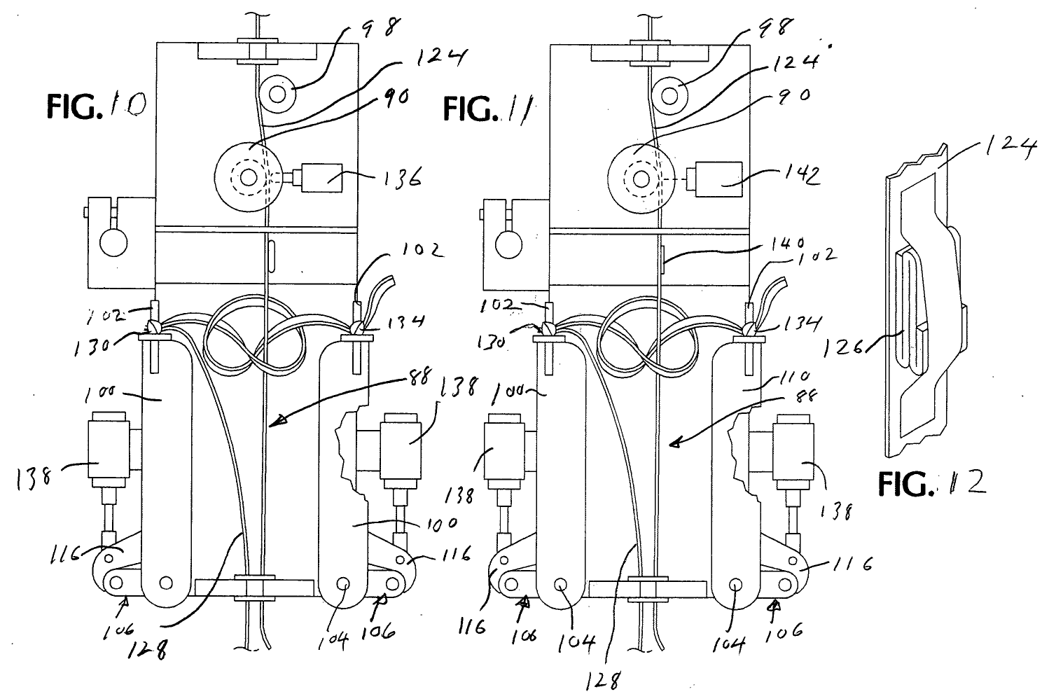

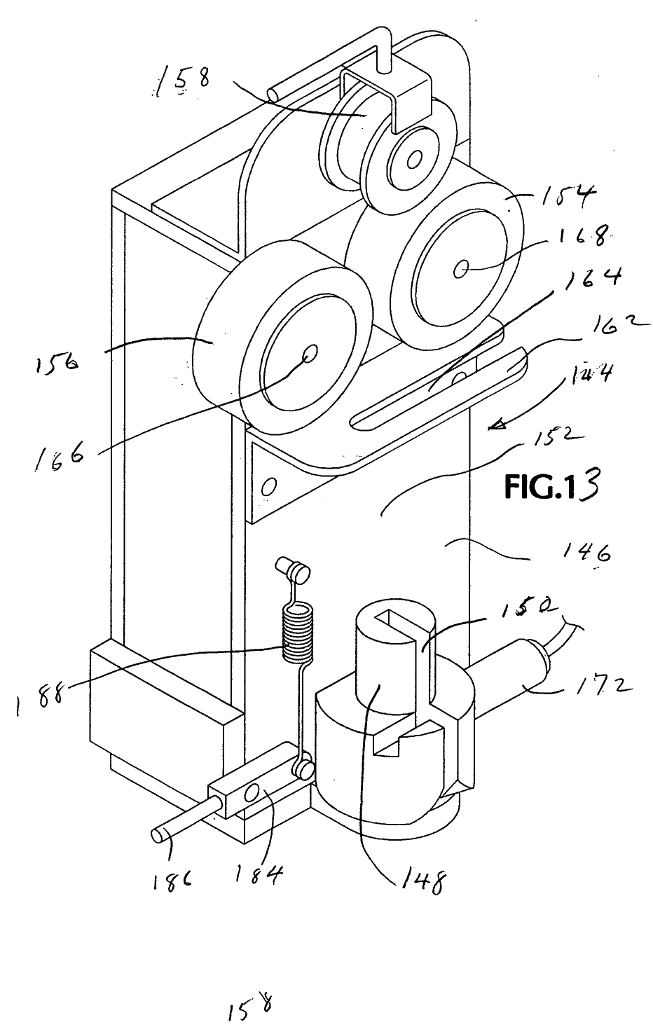

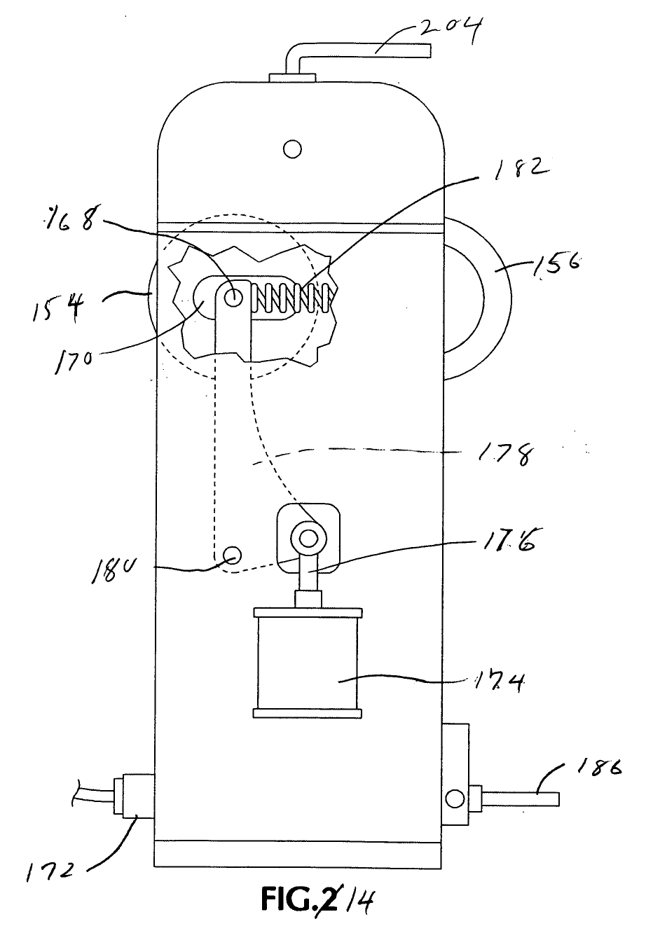

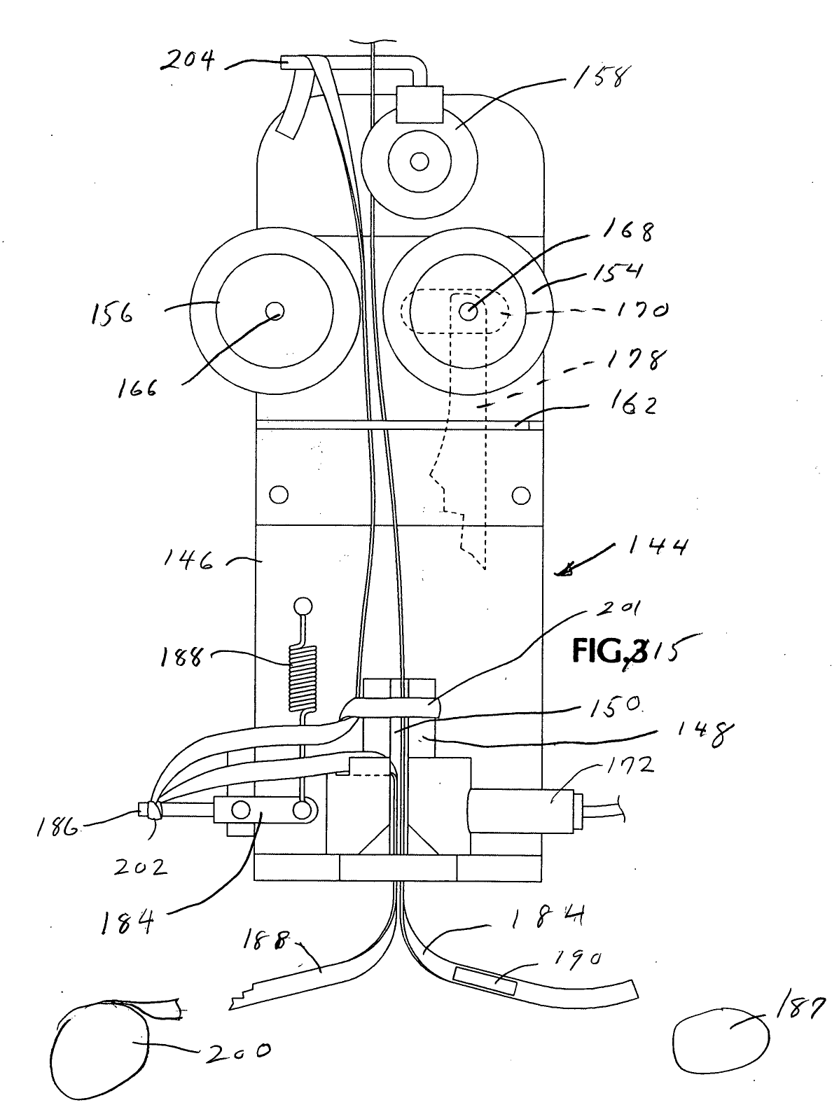

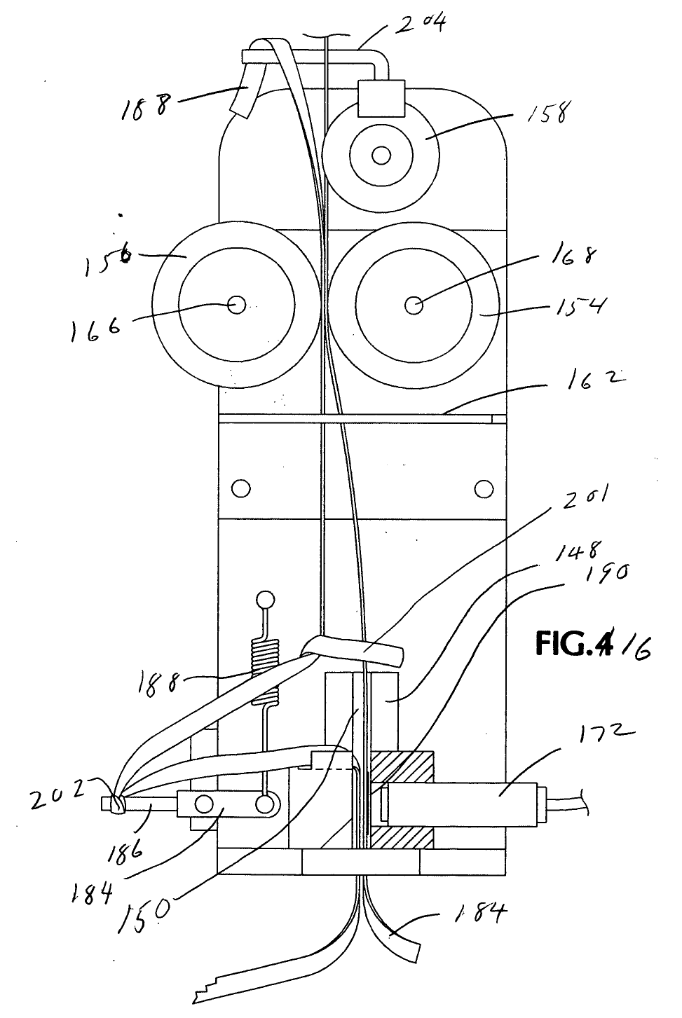

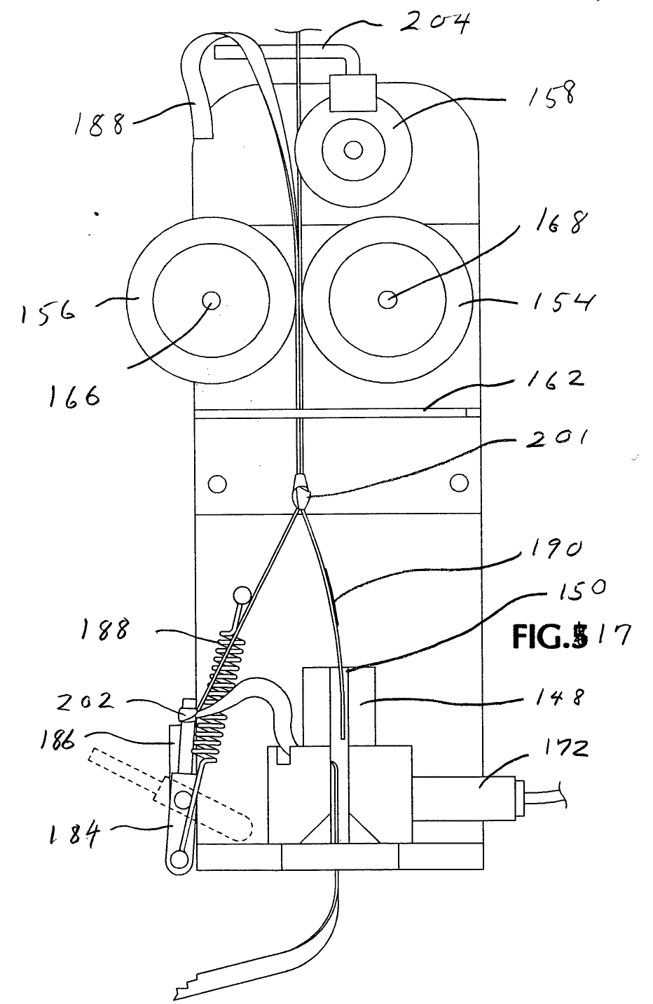

Rotatably mounted at the bottom of the frame 82, on the same side as the pathway 88, are a pair of arms 100. Posts 102 extend outwardly from the extremities of the arms. The arms are movable between a first position, FIG. 4, and a second position, FIG. 8. In the first position the arms are generally vertical and the posts are generally aligned with the tape with one post being on each side of the pathway. In the second position the arms are angled away from the tape and the posts are moved further from the pathway. The arms are mounted on one end of shafts which extend rotatably through the frame. The other end of the shafts are attached to levers 106. Thus, each lever 106 rotates with its associated arm 100. The levers are mounted on the shafts such that they are generally horizontal when the arms are generally vertical. When in this position the inner ends 108 of the levers are located close to the center of the frame, and the outer ends 110 of the levers are located outwardly from the sides of the frame.

A spring 112 extends between the top of the frame and the inner ends 108 of the levers and causes the levers to normally be oriented such that the arms are in the second position. The spring is connected to the inner ends of the levers by a cable 109 which extends from one lever through a pulley 111 which is attached to the spring to the other lever. Thus, each arm can move independently of the other arm.

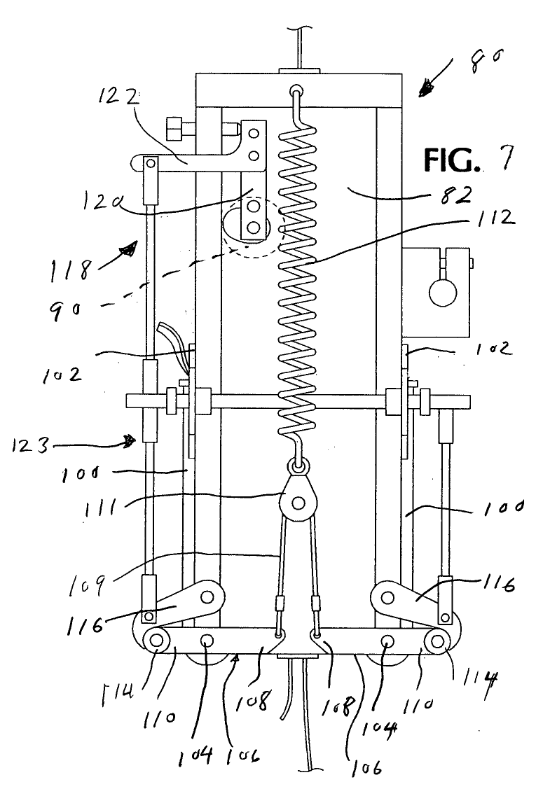

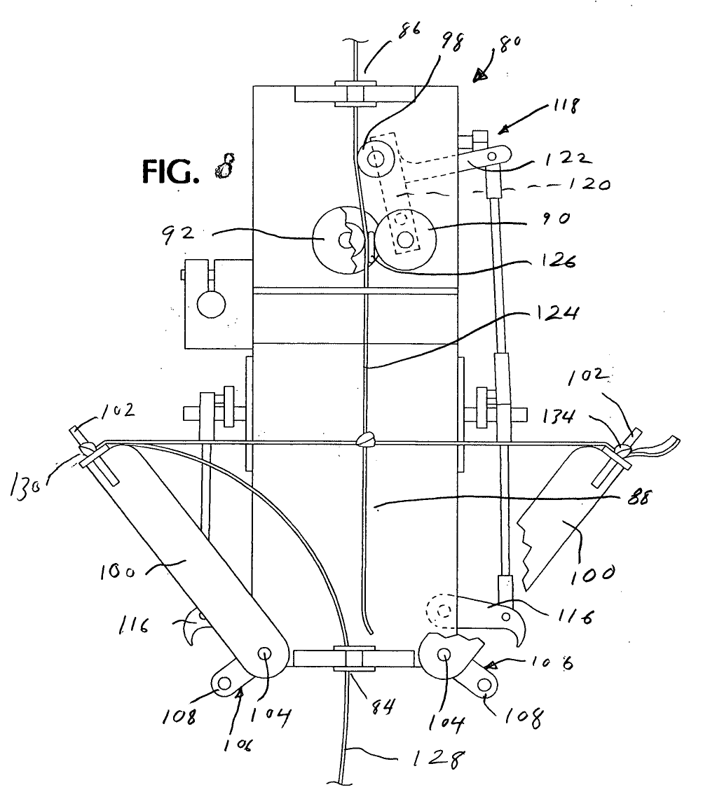

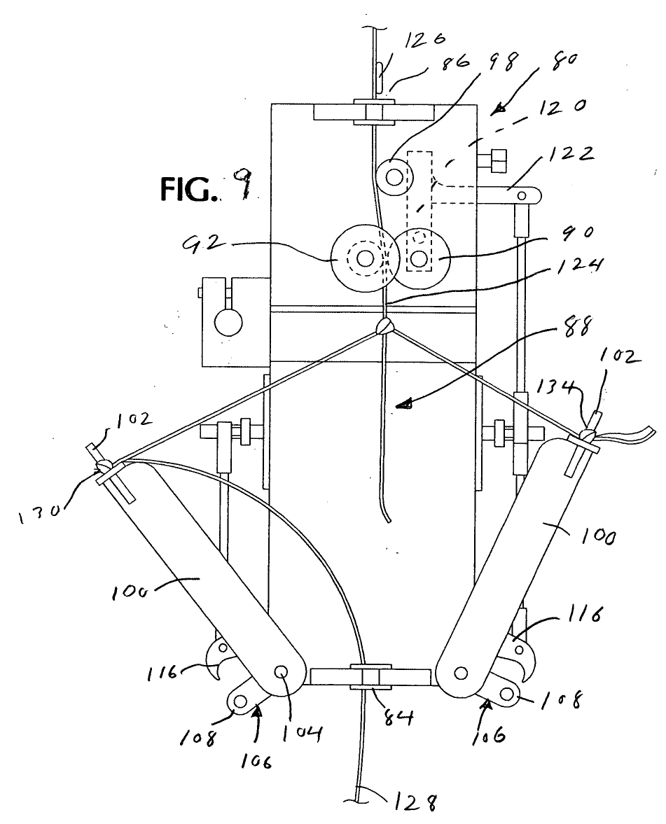

Located on the outer ends 110 of the levers 106 are cylindrical bearings 114 which can be rotated. Rotatably attached to each side of the frame is a catch 116. The catches rotate between latched positions, FIGS. 4-6, and unlatched positions, FIGS. 7 and 8. In the latched positions the catches engage the bearings 114 when the arms are in their first position and prevent rotation of the levers, and thus the arms. When the catches are moved to their unlatched positions, the levers are released and the spring 112 moves the arms to the second position.

The catches are moved from their latched to unlatched positions by means of a release mechanism 118. A bar 120 is rotatably mounted to the back side of the frame intermediate its ends. One end of the bar 118 carries the movable roller 90 and the other end is attached to an activation arm 122. When the movable roller is moved away from the fixed roller 92 the bar 112 is rotated and the extremity of the activation arm is raised. The extremity of the activation arm is connected to the catches through a linkage 124 such that when the extremity of the activation arm is raised the catches are moved out of their latched positions and the levers are released.

The tape used with the splicer mechanism 80 has a bulge 126 located in its tail, FIG. 11. In use, with the arms 100 latched in the first position by the catches 116, the leading edge of tape 124 from a first roll of tape is inserted through the entry passageway 84 and out of the exit passageway 86 and is inserted into a machine which applies the tape. The leading edge of tape 128 from a second roll of tape is inserted through the entry passageway 84. The leading edge of the tape 128 is then looped around one of the posts 102 and passed back through the loop and is pulled snug to provide a slip knot 130 on this post. The tape 128 is then looped around the tape 124 and is inserted back through the loop to form a loose knot 132 around the tape 124. The tape is then looped around the other post 102 and is inserted back through the loop and is pulled snug to form a slip knot 134 on that post. Other types of loose knots could be formed around posts 102 and the tape 128 and the tape 124 could be releasably affixed to the post by other means.

When the bulge 126 in the trailing edge of the tape 124 passes between the rollers 90 and 92, the movable roller 90 is moved sideways which acts as a trigger and causes the bar 120 to rotate and raise the activation arm 122 to release the catches 116 from the bearings 114 on the levers 106. The spring 112 then causes the arms 100 to rotate and the arms pull the slip knots 130 and 134 away from the tape 124 to tighten the loose knot 132 onto the tape 124, FIG. 7. The tape 128 then moves with the tape 124, FIG. 8, and the slip knots 130 and 134 are pulled off of the posts 102 and the tape 124 is joined to the tape 128.

If one of the slip knots pulls free of its post before the other, which will almost always occur, the associated arm will have less resistance to being pulled towards the second position by the spring 112. The pulley 111 then allows this arm to move toward the first position quicker which slows down the movement of the other arm until the slip knot on it can pull free.

Referring now to FIG. 9, instead of mechanically linking the trigger element to the release mechanism, movement of the movable roller causes it to activate a proximity switch 136 which in turn causes a pair of solenoids 138 to release the catches 116. Alternatively, a load cell (not shown), measures the tension in the tape and when the tension is momentarily increased due to the bulge passing between the rollers 90, 92, the solenoids are activated by the load cell to release the catches.

In another alternative embodiment, shown in FIG. 10, rather than a bulge a patch 140, which is optically distinct from the tape, is placed in the tail of the tape. The patch 40 can be clear, reflective, or just another color than the color of the tape. A photo cell 142, located alongside the pathway 88, detects when the patch passes by it and then activates the solenoids 138.

Referring now to FIG. 13, a second splicer mechanism 144 includes a frame 146. Rather than being shown as a flat plate like the frame 82 in the first mechanism 80, frame 146 is shown as a hollow box. Located at the lower end of the front of the frame is a tie block 148 having a central slot 150 through which the tape enters the splicer mechanism. The tape travels across the front surface of the frame along a defined passageway 150 and leaves the splicer mechanism at the upper end of the frame. Located near the upper end of the frame is a fixed roller 156 and a moveable roller 154 that the tape passes between. Located above the rollers 154 and 156 is an idler roller 158. A tape guide 162 having a slot 164 is located immediately below the rollers 154, 156.

Referring now also to FIG. 14, the fixed roller 156 is rotatably journaled on a axle 166 which is mounted on the front surface of the frame. The moveable roller 154 is rotatably journaled on an axle 168 which is mounted on a slider 170 which is located inside of the frame and is moveable transversely across the frame between a release position, FIGS. 14 and 15, where the fixed and moveable rollers are separated from one another by a sufficient distance that tape can move freely between the rollers, and a pinched position, FIGS. 16-18, where tape is pinched between the rollers and causes them to roll as it passes through the splicer mechanism.

Located on the tie block 148 is a sensor 172 which senses a marker located on the tape as the marker passes through the slot 150, as will be more fully explained later. The sensor activates a solenoid 174 having a piston 176 which is connected to one end of a lever 178 that is rotatably mounted inside the frame on a pin 180. The other end of lever 178 is connected to the slider 170. When the solenoid 174 is activated it rotates the lever 178 and moves the moveable roller 154 to the pinched position against the fixed roller 156. A spring 182 urges the moveable roller 154 to its released position when the solenoid 174 is not activated.

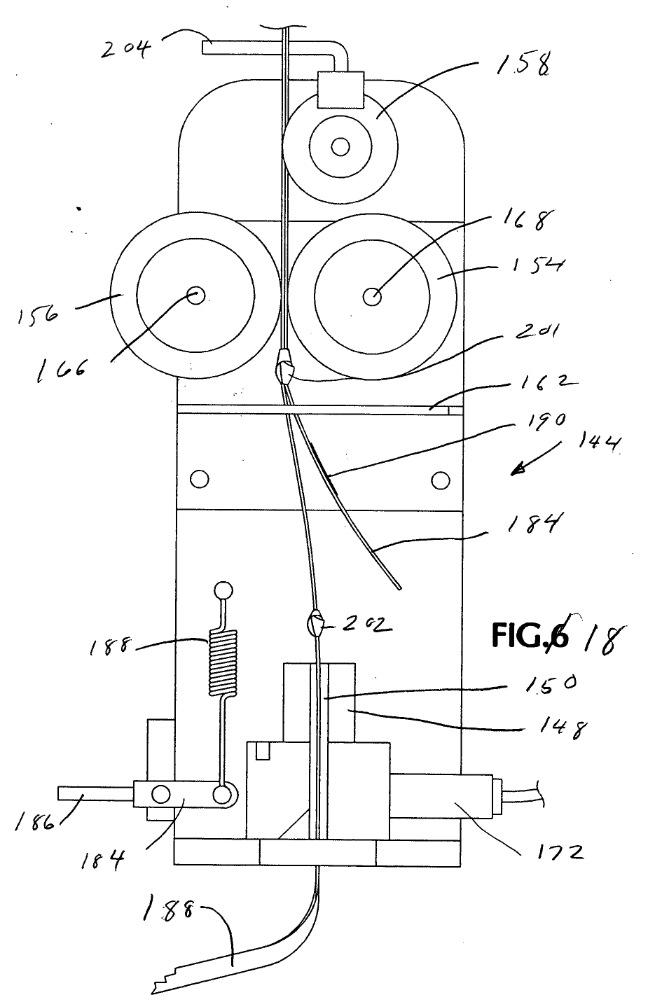

A tensioning device includes an arm 184 having a post 186 projecting from its distal extremity is rotatably mounted on the frame next to the tie block 148. The arm 184 is moveable between a first position, FIG. 17, where the post is vertical and is relatively close to the pathway 152, and a second position, FIGS. 13, 15, 16 and 18, where the post is horizontal and is further away from the passageway 152. A spring 188 urges the arm toward its second position, and creates a resistance against movement of the arm between its second and first positions.

The tape used with this splicer mechanism has a marker 190 located proximate its trailing edge. The marker is configured to be sensed by the sensor 172. The sensor and marker could be any type of sensing system available, such as an optical or electrical sensor. In the embodiment illustrated the sensor is a proximity switch and the marker is a strip of thin metal film which is incorporated in or wrapped around the tape.

Referring now to FIG. 15, a first tape 184 from a first roll 187 is inserted through the slot 150 in the tie block 148, along the pathway 152, through the rollers 154, 156 and out of the splicer block to a tape insertion mechanism which pulls the tape off of the roll. As indicated above, the first tape has a marker 190 proximate its trailing edge. The leading edge of a second tape 188 from a second roll 200 is passed through the slot 150 in the tie block alongside the first tape 184. The second tape is then looped around the outer surface of the tie block 148 and passed back through the loop to form a loose knot 201 around the tie block. The second tape is then looped around the post 186 and passed back through the loop and pulled tight to form a slip knot 202 on the post. The second tape is then passed between the rollers 154, 156 alongside the first tape 184. The end of the second tape is placed over a support 204 which projects from the upper end of the frame to keep it clear of the moving first tape.

When the marker 190 at the trailing edge of the first tape 184 passes through the tie block 148 it is sensed by the sensor 172. The sensor then activates the solenoid 174 which causes the lever 178 to be rotated and move the moveable roller 154 to its pinching position. When this occurs the first tape 184 causes the rollers 154, 156 to rotate which in turn causes the second tape to move along with the first tape. As the second tape starts to move the loose knot 201 is lifted off of the tie block 148, FIG. 16. Because the tape is tied to the post 186 and the spring 188 resists rotation of the arm 184, further movement of the tapes 184, 188 causes the loose knot 201 to be tightened around the first tape 184 as the arm rotates between its first and second positions, FIG. 17. When the arm has been rotated completely to its second position the knot 202 is pulled off of the post 186 and the second tape is joined to the first tape, FIG. 18.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A method of joining the tail of tape being fed from one roll to the leading edge of tape which will be fed from another roll, comprising:
(a) placing a marker in the trailing edge of tape from a first roll of tape;
(b) passing the tape from the first roll through a splicer mechanism;
(c) providing a second roll of tape;
(d) looping the leading edge of the tape from the second roll around the tape from the first roll and back through the loop to form a loose knot around the tape from the first roll; and
(e) providing a knot tying mechanism which causes the loose knot in the tape from the second roll to be tightened around the tape from the first roll when the marker in the trailing edge of the tape from the first roll passes through the splicer mechanism.

2. The method of claim 1 wherein said knot tying mechanism comprises:
(i) a frame, defining a pathway along which the tape travels as it is being fed;
(ii) a sensor which senses a marker located in the tape when said marker enters said pathway;
(iii) a pair of rollers located on said frame which the tape passes between as it moves along said pathway, at least one of said rollers being moveable between a release position where said rollers do not contact the tape and a pinching position where said rollers are in contact with one another such that as the tape passes between said rollers it causes them to turn;
(iv) a tensioning device which is moveable between a second position and a first position against a predetermined resistance;
(v) a tie block having an opening which the tape passes through, said tie block having an outer surface which circumscribes said pathway; and
(vi) an actuation device which causes said rollers to move to said pinching position when said marker is sensed by said sensor; and said method further comprises:
(a) providing a first roll of tape having a marker located in its trailing edge;
(b) feeding tape from said first roll along said passageway;
(c) providing a second roll of tape;
(d) looping the leading edge of the tape from the second roll around the outer surface of the tie block and back through the loop to form a loose knot around the tie block;
(e) then loosely affixing the leading edge of the tape from the second roll to said tensioning device;
(f) then passing the leading edge of the tape from the second roll between the rollers;
(g) so that when the marker in the trailing edge of the tape from the first roll passes the sensors the actuation device moves said one of said rollers to its pinching position and the leading edge of the tape from the second roll moves along with the tape from the first roll causing the loose knot in the second tape to be pulled off of the tie block and then causing said tensioning device to be moved between said second and first positions, thereby causing the loose knot in the second tape to be tightened around the first tape and then causing the second tape to be removed from the tensioning device.

3. A tape splicer mechanism for joining the tail of tape from one roll to the leading edge of tape that will be fed from another roll, comprising:
(a) a frame defining a pathway along which tape travels as it is being fed;
(b) a sensor which senses a marker located in the tape when said marker enters said pathway;
(c) a pair of rollers located on said frame which the tape passes between as it moves along said pathway, at least one of said rollers being moveable between a release position where said rollers do not contact the tape and a pinching position where said rollers are in contact with one another such that as the tape passes between said rollers it causes them to turn; and
(d) an actuation device which causes said rollers to move to said pinching position when said marker is sensed by said sensor.

4. The tape slicer of claim 3 including a tensioning device which is moveable between a second position and a first position against a predetermined resistance.

5. The tape splicer of claim 4 wherein said tensioning device comprises an arm having a pivot located on its distal extremity, said arm being moveable on said frame between a first position where said post is relatively close to said pathway and a second position where said post is further away from said pathway, said arm being normally biased towards its second position.

6. The tape splicer of claim 3 including a tie block having an opening which said tape passes through, said tie block having an outer surface which circumscribes said pathway.
